(19) United States
(12) Patent Application Publication
(10) Pub. No.: US 2004/0047559 A1
(43) Pub. Date: Mar. 11, 2004

(54) Multi-channel dispersion compensator for an optical transmission system

(76) Inventors: Jong-Won Lee, Seoul (KR); Sang-Hyuck Kim, Seoul (KR); Sang-Bae Lee, Seoul (KR)

Correspondence Address: JONES DAY, 222 EAST 41ST STREET, NEW YORK, NY, 10017, US

(21) Appl. No.: 10/313,067

(22) Filed: Dec. 6, 2002

(30) Foreign Application Priority Data
Sep. 11, 2002 (KR) 2002-54862

(51) Int. Cl. G02B 6/34; G02B 6/26

(52) U.S. Cl. 385/37; 385/27

(57) ABSTRACT

The present invention discloses a multi-channel dispersion compensator and an optical transmission system having the same. According to the multi-channel dispersion compensator of the present invention, chirped optical fiber gratings are coupled in parallel to an arrayed waveguide grating device. The arrayed waveguide grating device demultiplexes multiplexed optical signal pulses and again multiplexes the demultiplexed optical signal pulses.

### FIELD OF THE INVENTION

The present invention relates to a dispersion compensator for an optical transmission system, and more particularly, to a multi-channel dispersion compensator for an optical transmission system based on wavelength division multiplexing (“WDM”).

### BACKGROUND OF THE INVENTION

Optical transmission technologies have been rapidly improved due to the development of optical fiber technologies and light sources such as a semiconductor lasers. Particularly, wavelength division multiplexing, where optical signal pulses having different wavelengths are transmitted through a single optical fiber, has been established as the key technology to optical communications. Further, the problem of energy loss in optical signal pulses, caused by long distance transmission, has been resolved by the recent development of an Erbium-doped fiber amplifier (“EDFA”).

Where optical signal pulses in the wavelength band of 1,530-1,565 nm, which are the most commonly employed in optical transmission technologies, are multiplexed and transmitted though a single optical fiber, each of the optical signal pulses undergoes a different refraction due to the different refractive indices of the optical fiber with respect to each wavelength of the optical signal pulses. Due to the different refractive indices of the optical fiber, transmitting optical signal pulses through a single optical fiber over a long distance causes the phenomenon of “dispersion,” where optical signal pulses become spread along the time axis. As the required transmission distance becomes longer, the dispersion effect becomes even more prominent, to the degree that the transmitted optical signal pulses overlap each other, which makes it difficult to discriminate the optical signal pulses at the receiving end of the optical transmission system.

In an attempt to compensate for dispersion of optical signal pulses in the optical transmission system, a dispersion compensation fiber has been used. However, because of the expensive costs of the dispersion compensation fiber, a dispersion compensator using optical fiber gratings has come into use recently. Especially, chirped fiber gratings formed within the optical fiber, where the period of the gratings becomes longer or shorter, are now being widely used as a dispersion compensator for optical transmission systems, since they are small compared to the dispersion compensation fiber and compensate for the nonlinear phenomenon of dispersion of optical signal pulses.

A typical optical transmission system, including a multi-channel dispersion compensator, will now be described with reference to FIGS. 1A and 1B. FIG. 1A illustrates a structure of a WDM optical transmission system equipped with a multi-channel dispersion compensator. WDM optical transmission system 10 generally includes N:1 multiplexer 12, Erbium-doped fiber amplifier (EDFA) 14, multi-channel dispersion compensator 16, and 1:N demultiplexer 18. First, optical signal pulses (channel pulses) of different wavelengths λ₁-λₙ, where n indicates the number of channels, are generated from a plurality of laser diodes (not shown) included in the transmitting end of optical transmission system 10. N:1 multiplexer 12 receives and multiplexes these different optical signal pulses. The multiplexed optical signal pulses are transmitted to EDFA 14 through an optical fiber.

EDFA 14 amplifies the intensity of the multiplexed optical signal pulses whose intensities have been reduced due to the energy loss caused by the optical fiber. Although only one EDFA 14 between N:1 multiplexer 12 and multi-channel dispersion compensator 16 has been illustrated in FIG. 1A for the sake of brevity of explanation, several EDFAs may be used to enhance the performance of optical transmission system 10. Multi-channel dispersion compensator 16 compensates the dispersion of the multiplexed optical signal pulses, which have occurred due to the different refractive indices of the optical fiber with respect to the different wavelengths λ₁-λₙ of the optical signal pulses. Further details of multi-channel dispersion compensator 16 will be described below with reference to FIG. 1B.

Referring to FIG. 1B, the multiplexed optical signal pulses transmitted through EDFA 14 are inputted to port 1 of optical circulator 20 through optical fiber 20a, and then transmitted to optical fiber 20b through port 2 of optical circulator 20 by the path switching operation of optical circulator 20. As shown in FIG. 1B, a plurality of chirped fiber gratings 30a-30n are connected in series to optical fiber 20b. The optical signal pulse having, for instance, the longest wavelength λ₁ among the multiplexed optical signal pulses is reflected from first chirped optical fiber grating 30a, and other optical signal pulses are transmitted. The optical signal pulse having the second longest wavelength λ₂ is reflected from second chirped optical fiber grating 30b, and other optical signal pulses are transmitted. Finally, the optical signal pulse having the shortest wavelength λₙ is reflected from n-th chirped optical fiber grating 30n. The period of the grating is designed to become longer or shorter and can be predetermined based on the wavelengths of the multiplexed optical signal pulses used in optical transmission system 10. Further, although chirped optical fiber gratings 30a-30n have been shown and described as being physically connected to optical fiber 20b for the convenience of illustration, that the chirped optical fiber gratings are those which are formed within the optical fiber would be obvious to those skilled in the art.

In the above-mentioned conventional multi-channel dispersion compensator, the optical signal pulses λ₁-λₙ have different reflective paths having different lengths since they are reflected from chirped optical fiber gratings 30a-30n. Especially, each laser diode used for generating the optical signal pulse is not able to generate an optical signal pulse having a uniform wavelength, so that the optical signal pulses have different dispersions from each other depending on their wavelengths. For example, an optical signal pulse having a center wavelength of λ₁ consists of not only λ₁ but also other various wavelengths, λ₁±δ nm, within a predetermined range from λ₁. Accordingly, the longest wavelength λ₁+δ nm among the wavelengths consisting of the optical signal pulse having the center wavelength of λ₁ has a relatively low transmission velocity than the other wavelengths, and thus, undergoes excessive dispersion as it propagates over a long distance. On the other hand, the shortest wavelength λ₁−δ nm among the wavelengths consisting of the optical signal pulse having the center wavelength of λ₁ has a relatively fast transmission velocity than the other wavelengths, which results in less dispersion over the same distance. Consequently, the reflective path within chirped optical fiber grating 30a should be made as short as possible to compensate for the dispersion of the longest wavelength λ₁+δ nm, whereas lengthening the reflective path is required to compensate for the dispersion of the shortest wavelength λ₁−δ nm.

The dispersion-compensated optical signal pulses by chirped optical fiber gratings 30a-30n are inputted to port 2 of optical circulator 20, and then transmitted to 1:N demultiplexer 18 of optical transmission system 10 through port 3 of optical circulator 20 and optical fiber 20c. 1:N demultiplexer 18 demultiplexes the multiplexed optical signal pulses inputted through the optical fiber, and the demultiplexed optical signal pulses are finally transmitted to the receiving end (not shown), which includes a plurality of photo detectors (“PD”)(not shown).

According to the conventional multi-channel dispersion compensator described above, the optical signal pulse reflected from chirped optical fiber grating 30n, which is in the farthest position from optical circulator 20, has a relatively weak intensity compared to that from chirped optical fiber grating 30a, which is in the closest position from optical circulator 20, due to the series alignment of chirped optical fiber gratings 30a-30n. Therefore, the problem arises that the intensities of the optical signal pulses inputted to the multi-channel dispersion compensator are identical to each other, while the intensities of the dispersion-compensated optical signal pulses are different. In order to make the intensities of the dispersion-compensated optical signal pulses uniform, an additional device such as an optical filter is required.

### SUMMARY OF THE INVENTION

It is, therefore, an object of the present invention to provide a multi-channel dispersion compensator capable of uniformly maintaining the intensities of the dispersion-compensated optical signal pulses by using chirped optical fiber gratings positioned in parallel.

In accordance with an aspect of the present invention, a multi-channel dispersion compensator for an optical transmission system is provided which comprises an arrayed waveguide grating device for demultiplexing an input optical signal with a plurality of optical signal pulses having different multiplexed wavelengths and a plurality of chirped optical fiber gratings aligned in parallel for receiving the respective demultiplexed optical signal pulses. The plurality of chirped optical fiber gratings reflect the respective received optical signal pulses. The arrayed waveguide grating device multiplexes the reflected optical signal pulses to generate a multiplexed optical signal.

### BRIEF DESCRIPTION OF THE DRAWINGS

The above and other objects and features of the present invention will become apparent from the following description of the embodiment given in conjunction with the accompanying drawings, wherein:

FIG. 1A is a schematic view illustrating a structure of a WDM optical transmission system equipped with a multi-channel dispersion compensator;

FIG. 1B is a view showing a structure of a conventional multi-channel dispersion compensator shown in FIG. 1A; and

FIG. 2 is a view showing a structure of a multi-channel dispersion compensator according to an embodiment of the present invention.

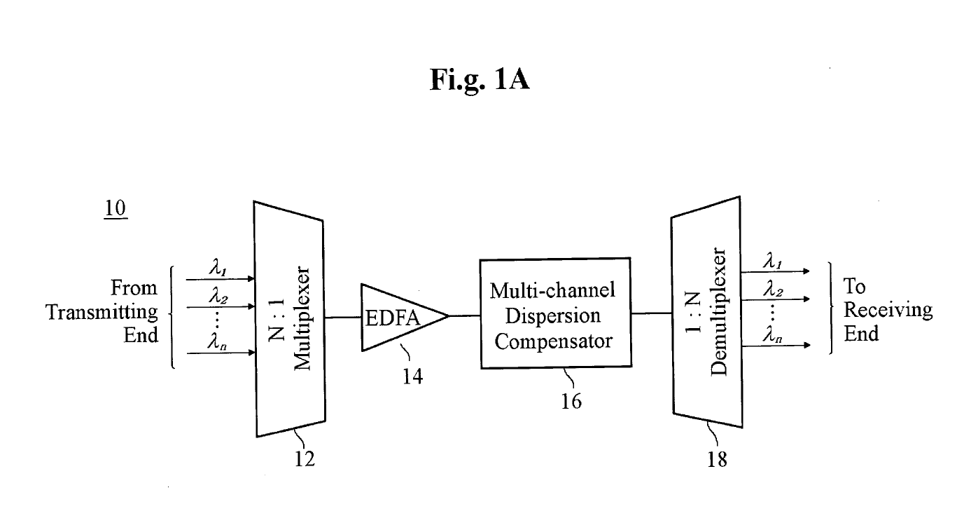

### DETAILED DESCRIPTION OF THE PRESENT INVENTION

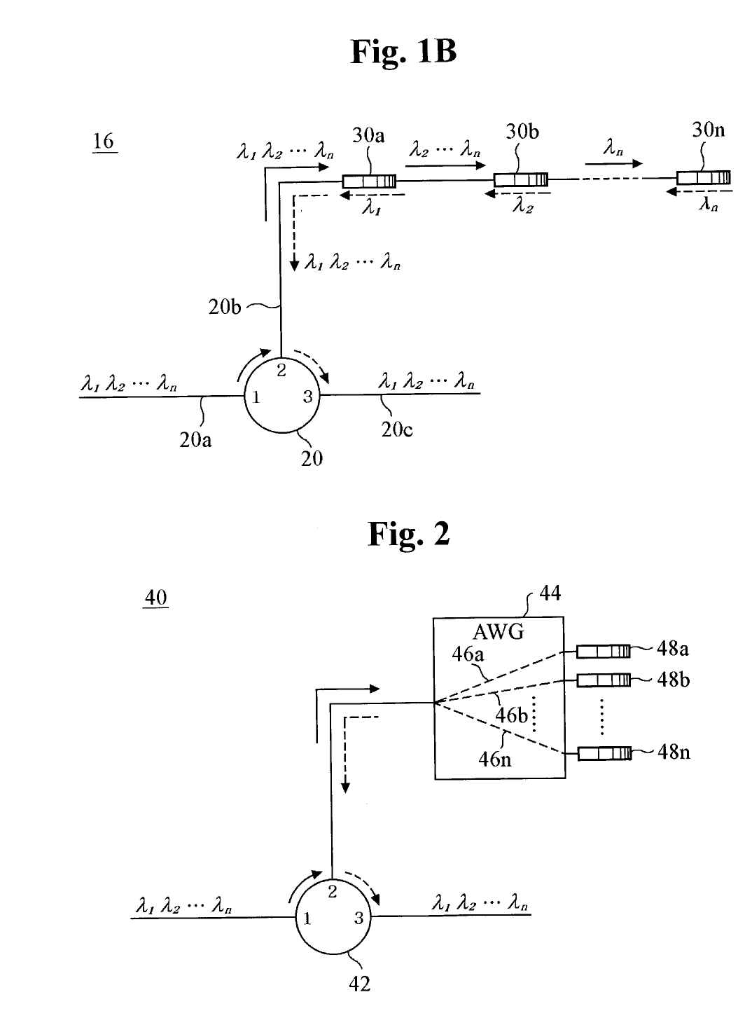

Referring to FIG. 2, a structure of a multi-channel dispersion compensator according to an embodiment of the present invention is shown. Multi-channel dispersion compensator 40 includes optical circulator 42, arrayed wave-guide grating (“AWG”) device 44 and a plurality of chirped optical fiber gratings 48a-48n.

The multiplexed optical signal pulses transmitted from an N:1 multiplexer and an EDFA are inputted to port 1 of optical circulator 42, and transferred to AWG device 44 through port 2 of optical circulator 42. AWG device 44 acts as a 1:N demultiplexer, which demultiplexes the multiplexed optical signal pulses. That is, an optical signal pulse having a center wavelength of λ₁ is transferred to first channel 46a of AWG device 44; an optical signal pulse having the center wavelength of λ₂ is transferred to second channel 46b of AWG device 44; and an optical signal pulse having the center wavelength of λₙ is transferred to n-th channel 46n of AWG device 44.

The intensities of the optical signal pulses, which are demultiplexed into respective channels 46a-46n of AWG device 44, are identical; however, the dispersions thereof are different from each other. In order to compensate the different dispersions, the n number of chirped optical fiber gratings 48a-48n are aligned in parallel to be coupled to respective channels of AWG device 44, as shown in FIG. 2. Each of chirped optical fiber gratings 48a-48n has a grating period and reflective wavelength, as predetermined based on the wavelengths of the optical signal pulses used in the optical transmission system. As mentioned above, the optical signal pulse having the center wavelength of λ₁, which can be generated by a laser diode (not shown), consists of the wavelength of λ₁ nm and the wavelengths of λ₁+δ nm, which are within a predetermined range from λ₁. With the structure of multi-channel dispersion compensator 40, the longest wavelength λ₁+δ nm among the wavelengths is reflected from the grating having the widest spacing within chirped optical fiber grating 48a so that the dispersion thereof can be compensated. The shortest wavelength λ₁−δ nm is reflected from the grating having the narrowest spacing within chirped optical fiber grating 48a in order to compensate the dispersion thereof.

With the structure of multi-channel dispersion compensator 40, the dispersion-compensated optical signal pulses lose their energy only from the chirped optical fiber gratings. In other words, the dispersion-compensated optical signal pulses have reduced intensities as compared to the optical signal pulses inputted to multi-channel dispersion compensator 40. However, they have a uniform intensity. Consequently, there is no need to provide additional devices such as an optical filter for making the intensities of the optical signal pulses uniform.

The dispersion-compensated optical signal pulses from chirped optical fiber gratings 48a-48n are again transferred to channel 46a-46n of AWG device 44. The transferred dispersion-compensated optical signal pulses are multiplexed by AWG device 44, which acts as not only a 1:N demultiplexer but also an N:1 multiplexer. Thereafter, the multiplexed dispersion-compensated optical signal pulses are transmitted to port 2 of optical circulator 42. By the path switching operation of optical circulator 42, the dispersion-compensated optical signal pulses are transmitted through port 3 of optical circulator 42 to an EDFA (not shown) for amplification, and then transmitted to the 1:N demultiplexer.

As described above, the intensities of the dispersion-compensated optical signal pulses can be uniformly maintained by using the multi-channel dispersion compensator of the present invention according to which the chirped optical fiber gratings, structured based on the wavelengths of the optical signal pulses used in the optical transmission system, are coupled in parallel to the arrayed waveguide grating device acting as both a 1:N demultiplexer and an N:1 multiplexer. The multi-channel dispersion compensator according to the present invention as explained with reference to FIG. 2 may be advantageously used in a dense wavelength division multiplexingbased optical transmission system.

While the present invention has been shown and described with respect to the particular embodiment, that many exchanges and modifications may be made without departing from the spirit and scope of the invention as defined in the appended claims will be apparent to those skilled in the art.

What is claimed is:

1. A multi-channel dispersion compensator for an optical transmission system, comprising:
an arrayed waveguide grating device for demultiplexing an input optical signal with a plurality of optical signal pulses having different multiplexed wavelengths; and
a plurality of chirped optical fiber gratings aligned in parallel for receiving the respective demultiplexed optical signal pulses, said plurality of chirped optical fiber gratings reflecting the respective received optical signal pulses,
wherein said arrayed waveguide grating device multiplexes the reflected optical signal pulses to generate a multiplexed optical signal.

2. The multi-channel dispersion compensator of claim 1, further comprising an optical signal pulse transmitter for transmitting the input optical signal to the arrayed waveguide grating device and for transmitting the multiplexed optical signal to an amplifier.

3. The multi-channel dispersion compensator of claim 2, wherein each of the plurality of chirped optical fiber gratings has a predetermined period of the grating and a predetennined reflective wavelength.

4. The multi-channel dispersion compensator of claim 3, wherein the multiplexed optical signal includes optical signal pulses having a uniform intensity.

5. An optical transmission system having a multi-channel dispersion compensator, wherein said multi-channel dispersion compensator comprises:
an arrayed waveguide grating device for demultiplexing an input optical signal with a plurality of optical signal pulses having different wavelengths multiplexed; and
a plurality of chirped optical fiber gratings aligned in parallel for receiving the respective demultiplexed optical signal pulses, said plurality of chirped optical fiber gratings reflecting the respective received optical signal pulses and said reflected optical signal pulses being multiplexed by said arrayed waveguide grating device to form a multiplexed optical signal.

6. The multi-channel dispersion compensator of claim 5, further comprising an optical signal pulse transmitter for transmitting the input optical signal to the arrayed waveguide grating device and for transmitting the multiplexed optical signal to an amplifier.

7. The multi-channel dispersion compensator of claim 6, wherein each of the plurality of chirped optical fiber gratings has a predetermined period of the grating and a predetermined reflective wavelength.

8. The multi-channel dispersion compensator of claim 7, wherein the multiplexed optical signal includes optical signal pulses having a uniform intensity.
